(19) United States
(12) Patent Application Publication
(10) Pub. No.: US 2012/0093206 A1
(43) Pub. Date: Apr. 19, 2012

(54) RADIO DATA SYSTEM MONOPHONIC DEMODULATION

(75) Inventors: Tg Vishwanath, San Diego, CA (US); Luca Blessent, San Diego, CA (US); Koorosh Akhavan, San Diego, CA (US); James T. Masamoto, San Diego, CA (US)

(73) Assignee: QUALCOMM INCORPORATED, San Diego, CA (US)

(21) Appl. No.: 13/250,727

(22) Filed: Sep. 30, 2011

Related U.S. Application Data
(60) Provisional application No. 61/394,299, filed on Oct. 18, 2010.

(51) Int. Cl. H04B 15/00; H04B 1/38; H04B 1/10

(52) U.S. Cl. 375/222; 375/350

(57) ABSTRACT

A method of switching between Coherent and Non-Coherent demodulation based on computed metrics, in cases where stereo FM broadcasting stations do not adhere to RDS broadcast specifications. Re-utilizes existing hardware to demodulate RDS data in mono. The residual frequency offset is resolved using a Non Coherent demodulator and a time tracking algorithm. RDS data relies on the 57 kHz sub-carrier that is generated using 19 kHz pilot tone. In Mono broadcasting pilot tone is not present. A local 57 kHz free running signal is generated, and this is then used to demodulate the RDS data in Non-Coherent mode.

### CLAIM OF PRIORITY UNDER 35 U.S.C. §119

The present application for patent claims priority to Provisional Application No. 61/394,299 entitled, “RADIO DATA SYSTEM MONOPHONIC DEMODULATION” filed Oct. 18, 2010, and assigned to the assignee hereof and hereby expressly incorporated by reference herein.

### BACKGROUND

1. Field

The present invention relates generally to wireless communications, and more specifically to Radio Data System data demodulation.

2. Background

The capabilities of cellular handheld devices increase every day as advances in microchip technology enable more circuits and functionality to be built into the devices. Consequently, cellular handheld devices have quickly evolved beyond simple communication devices to become personal communication/entertainment/information resources. One source of information being incorporated into cellular handheld devices is the Radio Data Systems (RDS), which communicates broadcast radio digital data to properly equipped FM receivers. Broadcast radio data is typically used in FM radio stations, which transmit stereo-multiplex or monophonic (mono) signals in the VHF frequency band. This data may be obtained by any FM radio having the necessary circuitry and functionality to receive and decode the RDS signal. Broadcast radio data can be used by the FM radio stations to provide information relating to their radio broadcast. An FM radio, which receives the broadcast radio data, can reproduce that data on a display.

RDS is a technology that has been deployed in several countries around the world. Within the United States, the equivalent system is known as the radio broadcast data system (RBDS). For simplicity, references to RDS herein are intended to encompass RBDS, and the description of RDS technology is based on the U.S. RBDS implementation.

The RDS system makes use of a 57 kilohertz (kHz) subcarrier within an FM frequency band to transmit a low data rate signal. The RDS data stream is produced by the FM broadcaster, and so is unique to the broadcasting station. Not all FM broadcasts include RDS data, as it is an option available to broadcasters, but not a requirement. Data is transmitted at a rate of 1187.5 bits per second, but with error encoding and other overhead communication, the system transmits about 300 bits per second of usable data.

The 57 kHz subcarrier used by the broadcaster to carry the data must be coherently generated as a third harmonic of the 19 kHz pilot tone used by the broadcasting station so that the data can be decoded by a receiver with no frequency offset. Many FM broadcasters in stereo mode fail to meet RDS standard specifications in terms of RDS 57 kHz subcarrier phase alignment with the 3rd harmonic of 19 kHz pilot. This failure results in a residual frequency error on the received RDS signal and as a result, the RDS data cannot be demodulated. The widespread use of RDS in mono broadcasting having no 19 kHz pilot also results in the inability to demodulate RDS data.

There is therefore a need in the art for an easily implemented method and apparatus for switching between Coherent and Non-Coherent demodulation based on computed metrics, in cases where FM broadcasting stations do not adhere to specifications either by broadcasting non coherent RDS data where the 57 kHz data carrier is not locked to the 19 kHz pilot tone or by broadcasting RDS data in a mono signal having no 19 KHz pilot.

### BRIEF DESCRIPTION OF THE DRAWINGS

FIG. 1 is a diagram illustrating an example of a radio broadcast network in which radio data system non-coherent demodulation can be used;

FIG. 2 is a conceptual block diagram illustrating an example of a hardware configuration for non-coherent RDS demodulation;

FIG. 3 is a conceptual block diagram illustrating an example of a hardware configuration for differential decoding for non-coherent RDS demodulation;

FIG. 4 is a flowchart illustrating exemplary operational modes of radio data system coherent and non-coherent demodulation;

FIG. 5 is a flowchart illustrating an exemplary algorithm for non-coherent RDS demodulation; and

FIG. 6 is a block diagram illustrating an exemplary wireless device capable of RDS non-coherent demodulation.

### DETAILED DESCRIPTION

The word “exemplary” is used herein to mean “serving as an example, instance, or illustration.” Any embodiment described herein as “exemplary” is not necessarily to be construed as preferred or advantageous over other embodiments.

The terms “wireless device” and “mobile device” as used herein refers to a wireless communication device such as a cellular telephone, wireless terminal, user equipment, laptop computer, High Data Rate (HDR) subscriber station, access terminal, or other personal communication system (PCS) device. The device may be either mobile or stationary.

The term “non-coherent Radio Data Signal” as used herein refers to a Radio Data Signal having no 19 kHz pilot, or having a 57 kHz subcarrier that is not synchronized to a 19 kHz pilot. A “non-coherent Radio Data Signal” is a Radio Data Signal having an unsynchronized subcarrier.

Many broadcasting stations in stereo mode, fail to meet RDS standard specifications in terms of RDS 57 kHz subcarrier phase alignment with a 3^{rd} harmonic of the 19 kHz pilot. Failure to maintain phase alignment results in a residual frequency error on the RDS signal prohibiting demodulation and decoding of broadcast data. The use of RDS in Mono broadcasting having no pilot tone is also widespread. The disclosed embodiments resolve this frequency offset or lack of pilot signal comprising a non-coherent demodulator and a time tracking algorithm. In Mono broadcasting, a local 57 kHz free running signal reference is generated and then used to demodulate the RDS data in non-coherent mode.

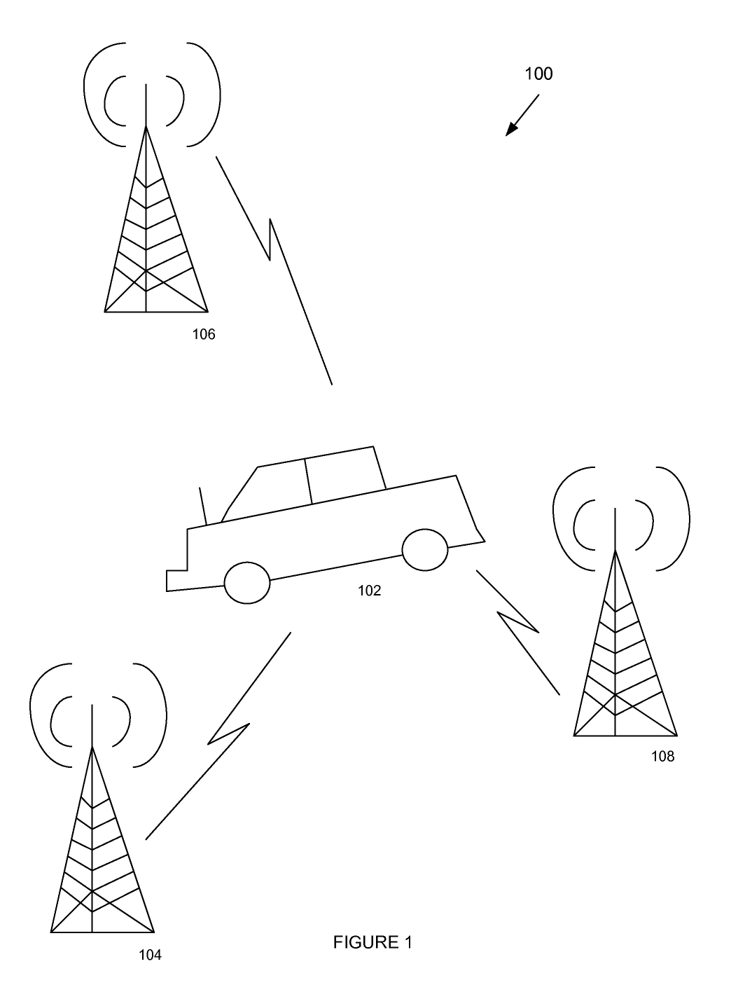

FIG. 1 is a diagram illustrating an example of a radio broadcast network in which RDS non-coherent demodulation can be used. As seen in FIG. 1, radio broadcast network 100 includes multiple base stations 104, 106 and 108 for transmitting radio broadcasts. The radio broadcasts are typically transmitted as stereo-multiplex signals in the VHF frequency band. Radio data system (RDS) data can be broadcast by base stations 104, 106 and 108 to display information relating to the radio broadcast. For example, the station name, song title, and/or artist can be included in the RDS data. In addition or in the alternative, the RDS data can provide other services, such as showing messages on behalf of advertisers.

An exemplary utilization of the RDS data of this disclosure is for the European RDS standard, which is defined in the European Committee for Electrotechnical Standardization, EN 50067 specification. Another exemplary utilization of the RDS data of this disclosure is for the North American radio broadcast data system (RBDS) standard (also referred to as NRSC-4), which is largely based on the European RDS standard. As such, the RDS data of this disclosure is not limited to one or more of the above standards/examples. The RDS data can include, additionally or alternatively, other suitable information related to a radio transmission.

A receiver 102 that receives the RDS data can reproduce that data on a display of the receiver or a host system. In this example, the receiver 102 is depicted as hosted by a car. However, receiving station 102 should not be limited as such, and can also represent, for example, a person, another mobile entity/device, or a stationary entity/device. Furthermore, the receiver can represent a computer, a laptop computer, a telephone, a mobile telephone, a personal digital assistant (PDA), an audio player, a game console, a camera, a camcorder, an audio device, a video device, a multimedia device, a component(s) of any of the foregoing (such as a printed circuit board(s), an integrated circuit(s), and/or a circuit component(s)), or any other device capable of supporting RDS. A host system can be stationary or mobile, and it can be a digital device.

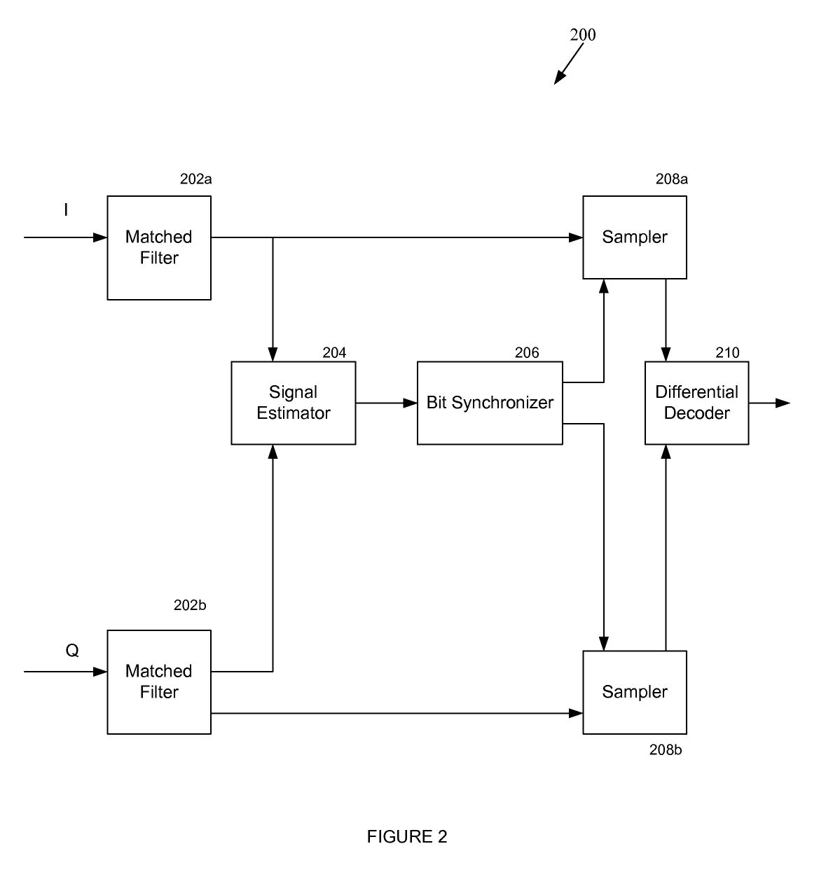

FIG. 2 is a conceptual block diagram illustrating an example of a hardware configuration for non-coherent RDS demodulation 200. In coherent mode, the IQ Signal Detector block is used to detect the presence of the RDS signal either in the I arm or the Q arm of the received signal. In Non-Coherent mode, this selection of either the I or Q arm is not necessary because the signals from both arms are simultaneously used for demodulation. To address the residual frequency offset problem, a non-coherent demodulation approach with time tracking is implemented by providing a register bit for configuring receiver hardware to operate in either Coherent or Non-Coherent mode. Rather than implementing costly frequency tracking loops to correct for the frequency offset, the difference is taken between two conjugated symbols (phase) for determining data bit values. This difference will be restricted according to the frequency offset. For example, in one embodiment using BPSK modulation, if there is a frequency offset, the data constellation is rotated in proportion to the offset. In order to correct the offset for each received data bit, its symbol is multiplied by the conjugate of the previous symbol. This conjugation operation merely requires a multiplier and a summer. The sign of the real part of the product conjugate is taken to determine whether the value is positive or negative and the real part is mapped to determine the binary value of the received data bit. This process can be performed by hardware components, or alternatively using a processor to read the symbol from the hardware and perform the mathematical operations. Both I and Q arms are processed by the matched filters and the phase between two consecutive symbols at the output of the matched filters is used to decode the bit.

I and Q arms of the received signal are oversampled and processed separately by matched filters 202a and 202b respectively. The matched filters 202a and 202b convolve the I and Q samples with matched filter coefficients to produce improved oversampled I and Q filtered signal outputs. In one exemplary embodiment, 16 times oversampling is produced. One skilled in the art would understand that other embodiments may produce any number of oversamples without departing from the scope of the invention. The oversampled filtered signals, having 16 samples of the transmitted bit symbol, are input to Signal Magnitude Estimator 204. Signal Magnitude estimator 204 detects the peak signal magnitude values of the 16 samples using signal amplitude estimations for input to Bit Synchronizer 206.

Bit Synchronizer 206 performs time tracking of the 16 times oversampled matched filtered signals determining the optimal sampling point and also when the peak sampling point rolls over on either ends to perform appropriate bit Add/Drop from the samples. Time tracking is achieved by monitoring the peak index calculated in the bit synchronizer. The bit synchronizer averages the 16 sample phases in a bit period, over a programmable number of bits. In the exemplary embodiment having 16 times oversampling, the number of bits is 64. One skilled in the art would understand that other embodiments may produce any number of bits without departing from the scope of the invention. Thus, the peak index of the exemplary embodiment is updated every 64 bits and this peak index is used to demodulate the received signal at the end of every bit boundary. In the event that the peak index shifts from 0 to 15, an additional bit is inserted. In a simplified embodiment, the same bit is repeated. If the peak index shifts from 15 to 0, a bit is dropped. In exemplary embodiments, a 1-bit register (not shown) allows selection between Coherent and Non Coherent modes of operation. A programmable 5-bit register (not shown) sets a threshold value needed for the bit add/drop mechanism.

Thus, the best sample of the 16 samples is selected by Bit Synchronizer 206 by averaging a running sum of the signal magnitudes over a predetermined window to calculate a peak sample index from the 16 samples output by matched filters 202a and 202b using the running sums and Samplers 208a and 208b.

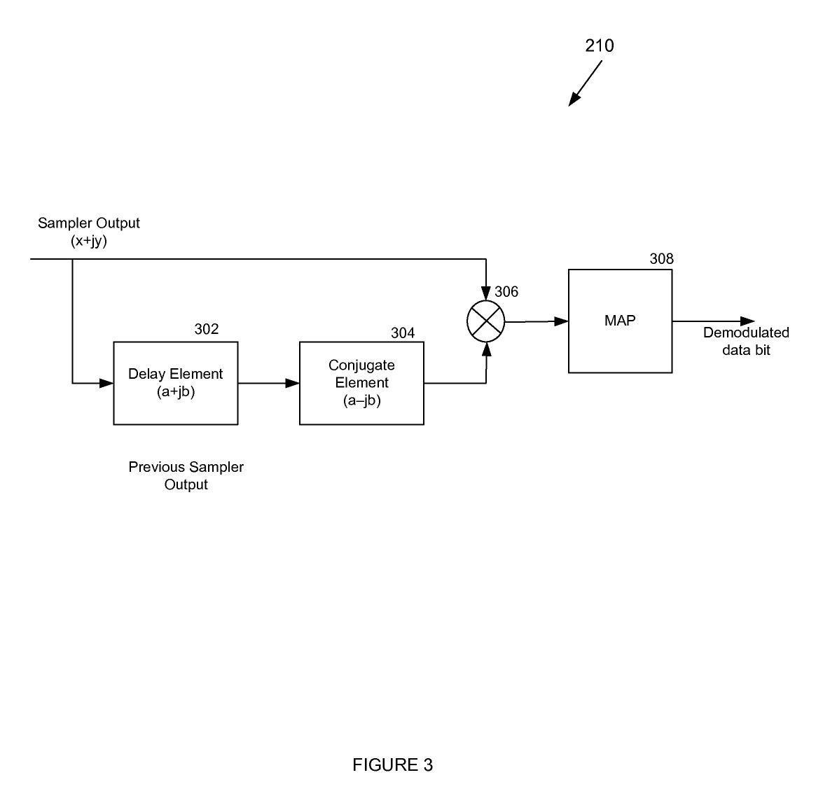

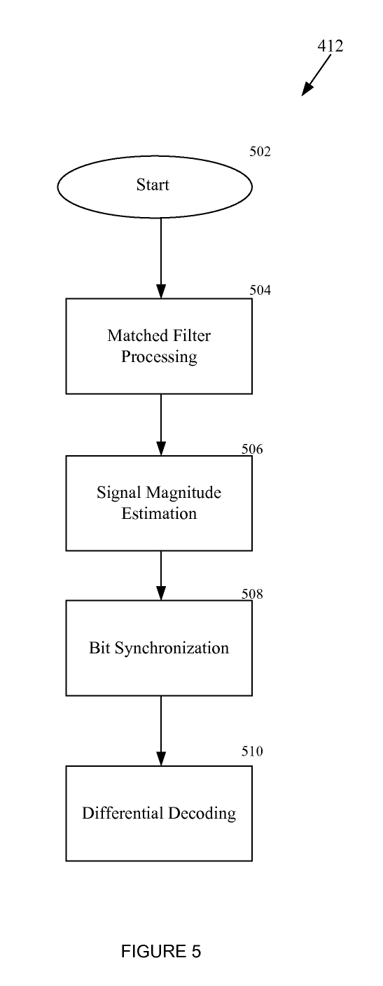

The best sample selected by Bit Synchronizer 206 is input to differential decoder 210 for determination of its binary data bit value. Differential Decoder 210 outputs the received demodulated RDS data bit value of 0 or 1. The differential decoding operation of the differential decoder 210 is detailed below in FIG. 3. An exemplary method for non-coherent demodulation is detailed in FIG. 5.

FIG. 3 is a conceptual block diagram illustrating an example of a hardware configuration for differential decoding for non-coherent RDS demodulation 300. The selected sample output from Sampler 208 is input to Multiplier 306 and Delay Element 302. Delay Element 302 stores the previous sample so that it can be conjugated by Conjugate Element 304 in order to find the angle, or phase difference, between the previous sample and the current sample. Multiplier 306 multiples the conjugated value of the previous sample with the current sample to produce the phase of the current received symbol. The output of Multiplier 306 is provided to Map element 308, which maps the phase of the Multiplier 306 output real portion of the conjugate (phase) of the current symbol to a RDS data bit value of either 1 or 0.

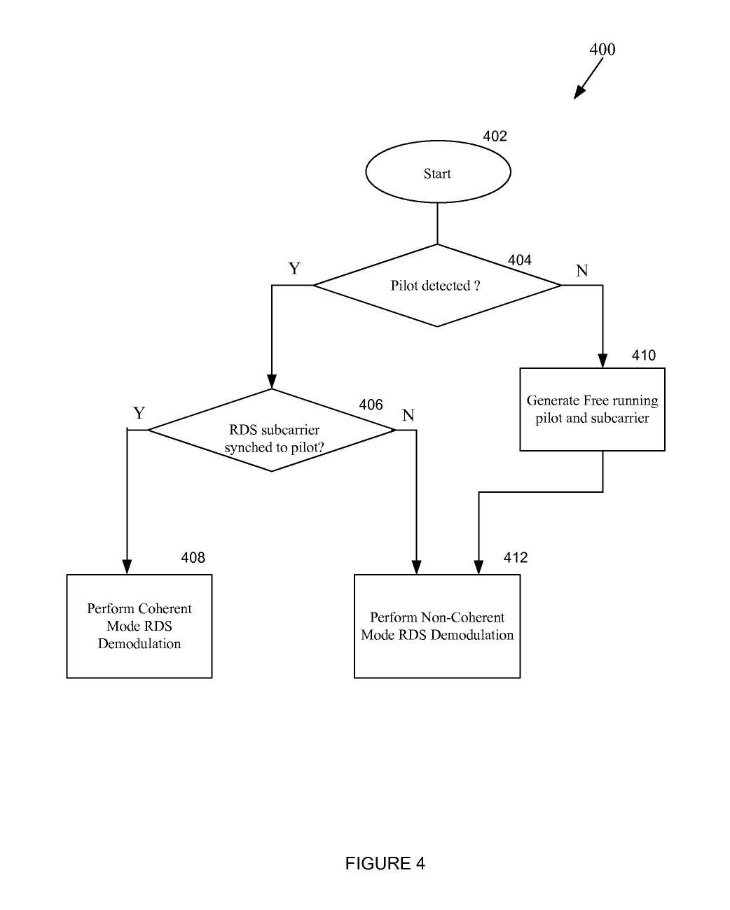

FIG. 4 is a flowchart illustrating exemplary operational modes of radio data system demodulation 400. Non-coherent stereo RDS demodulation provides demodulation of RDS data when FM broadcasters in stereo mode fail to meet RDS standard specifications by transmitting a 57 kHz subcarrier in phase alignment, i.e locked, with the 3rd harmonic of the 19 kHz stereo pilot. However, the widespread use of RDS in mono broadcasting, having no 19 kHz pilot, also results in the inability to demodulate RDS data. Due to lack of a 19 kHz pilot tone in mono transmission, the coherent reference for detection of a RDS signal cannot be obtained by the use of an ordinary phase-lock tracking loop. In such situations, a coherent demodulation scheme will also fail to lock on to a functional 19 kHz pilot reference. Non-coherent mono RDS demodulation configures generation of a free running 19 kHz signal. This local free running 19 kHz reference is used to generate a local 57 kHz reference and the RDS data is then demodulated from the mono signal in the same manner as the non-coherent RDS stereo signal. No changes or additional hardware are required in the RDS modem to incorporate this feature. A 1-bit register allows non-coherent RDS demodulation to operate in either stereo or mono mode. RDS demodulation disclosed herein supports coherent demodulation and non-coherent demodulation modes of operation under firmware, hardware, or processor control.

Coherent demodulation mode is compatible with any transmission having a 57 kHz subcarrier locked to a 19 kHz pilot. This mode allows RDS data to be received from broadcast stations that adhere to RDS specifications with improvement in sensitivity compared to non-coherent demodulation mode. Coherent demodulation mode will switch to non-coherent demodulation mode of operation if coherent mode data demodulation is unsuccessful, becomes degraded, or the received signal is broadcast from a mono station. Non-Coherent demodulation mode is compatible with any stereo broadcast station whose 57 kHz signal is not locked to its 19 kHz pilot or any mono broadcast station.

Operational mode selection begins in step 402 when a new broadcast signal is received. Control flow proceeds to step 404.

In step 404, the receiver determines whether the received broadcast signal comprises a 19 kHz pilot signal. If a 19 kHz pilot signal is present, control flow proceeds to step 406 where synchronization of the 57 kHz RDS data subcarrier will be examined to determine synchronization. Otherwise, control flow proceeds to step 410 for processing a mono signal having no pilot.

In step 406, if a synchronized 57 kHz RDS data sub-carrier, in phase with the 19 kHz pilot signal, is present control flow proceeds to step 408 where RDS data is demodulated in coherent mode. Otherwise, control flow proceeds to step 412 where RDS data is demodulated in non-coherent mode. Non-coherent RDS data demodulation mode is detailed in FIG. 5.

In step 410, a free running 19 kHz and/or a 57 kHz signal is locally generated and control flow proceeds to 412 where RDS data is demodulated from the mono signal in non-coherent mode.

FIG. 5 is a flowchart illustrating an exemplary algorithm for non-coherent RDS demodulation 412. Non-coherent RDS data modulation begins in step 502 when either a mono signal having no pilot, or a stereo signal having an unsynchronized RDS data subcarrier is received. Control flow proceeds to step 504.

In step 504, I and Q arms of the received signal are processed separately by convolving the I and Q samples with matched filter coefficients to produce multiple improved bit samples. Control flow proceeds to step 506.

In step 506, a bit synchronization process selects the best sample from the multiple improved samples. Control flow proceeds to step 510.

In step 510, the selected sample is differentially decoded to produce a binary data bit value of either 0 or 1.

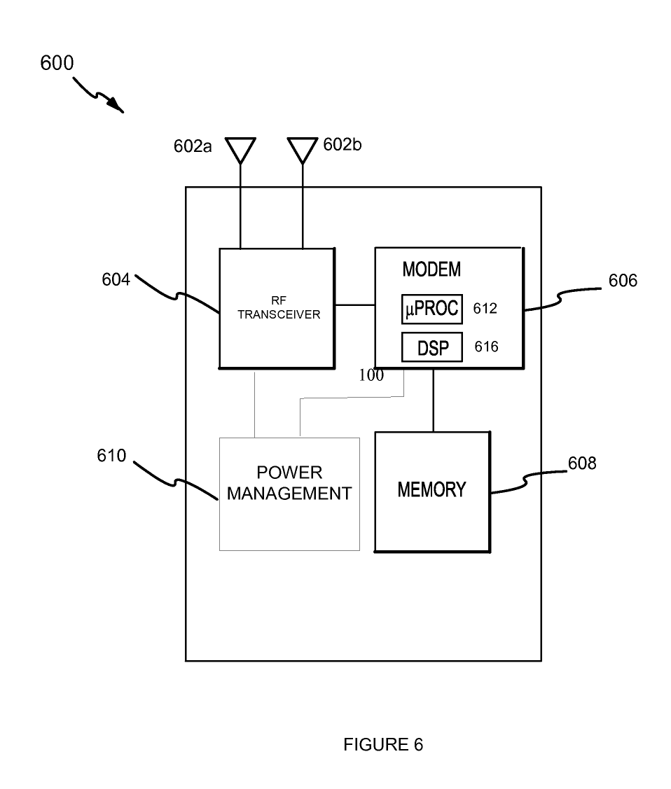

FIG. 6 is a block diagram illustrating an exemplary wireless device capable of RDS non-coherent demodulation 600. Wireless device 600 comprises a wireless communication transceiver 604 and associated antennas 602a, 602b capable of sending and receiving wireless communication signals. Modem 606 comprises the appropriate microprocessor(s) 612, digital signal processor(s) 614 and other suitable hardware, such as a correlator bank, for processing signals. Power management 610 controls power for various components of wireless device 600. Memory 608 is coupled to modem 604 as necessary for implementing various modem processes and functionality for RDS non-coherent demodulation. Wireless device 600 may comprise an appropriate user interface with alphanumeric keypad, display, microphone, speaker, and other necessary components (not shown). It will be appreciated by those skilled in the art that Wireless device 600 may comprise a variety of components not shown.

The methodology for RDS non-coherent demodulation described herein may be implemented by suitable instructions operating on the microprocessor 612 and memory 608 of Wireless device 600, but is certainly not limited to such an implementation and may alternatively be implemented in hardware circuitry. The microprocessor 612 is connected to power management 610 and memory 608 having code or instructions directing the microprocessor 612 to perform RDS non-coherent demodulation. Memory 608 may comprise instructions for performing hybrid RDS non-coherent demodulation. The memory 608 may include RAM memory, flash memory, ROM memory, EPROM memory, EEPROM memory, registers, a hard disk, a removable disk, a CD-ROM, or any other form of storage medium or computer readable media known in the art. In an exemplary aspect, the control processor 612 executes instructions stored in memory 608 according to the steps of FIGS. 1-5 to perform RDS non-coherent demodulation.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed:

1. A method for receiving Radio Data System signals comprising:
receiving a Radio Data Systems signal having no pilot, or an unsynchronized data subcarrier;
filtering the received signal to produce multiple improved bit samples;
estimating the signal magnitude of the multiple bit samples;
selecting the best bit sample from the multiple samples; and
differentially decoding the selected sample to produce a received RDS data bit value.

2. The method of claim 1 wherein receiving the Radio Data Systems signal comprises receiving a mono signal and generating a local 19 kHz local clock signal.

3. The method of claim 2 wherein a local 57 kHz local clock signal is generated from the local 19 kHz clock signal.

4. The method of claim 1 wherein the multiple improved bit samples comprise 16 match filtered bit samples.

5. The method of claim 1 wherein estimating the signal magnitude comprises calculating a peak index for the multiple bit samples.

6. The method of claim 5 wherein the peak index is updated every 64 bits.

7. The method of claim 1 wherein differentially decoding the selected sample comprises conjugating a current bit sample with a previous bit sample to produce a phase angle between the two samples and using the phase angle to map the selected sample to a binary data bit value of either 0 or 1.

8. The method of claim 1 wherein filtering the signal comprises processing an I component and a Q component of the received signal with separate matched filters.

9. The method of claim 1 wherein selecting the best sample comprises averaging a running sum of the estimated signal magnitudes.

10. The method of claim 1 wherein selecting the best bit sample comprises adding and/or dropping bit samples.

11. A Radio Data System receiver comprising:
an antenna for receiving Radio Data Systems signal having no pilot, or a an unsynchronized data subcarrier;
matched filters for filtering the received signal to produce multiple improved bit samples;
a signal estimator for estimating the signal magnitude of the multiple bit samples;
a bit synchronizer for selecting the best bit sample from the multiple samples; and
a differential decoder for differentially decoding the selected sample to produce a received RDS data bit value.

12. The Radio Data System receiver of claim 11 wherein receiving the Radio Data Systems signal comprises receiving a mono signal and generating a local 19 kHz local clock signal.

13. The Radio Data System receiver of claim 12 wherein a local 57 kHz local clock signal is generated from the local 19 kHz clock signal.

14. The Radio Data System receiver of claim 11 wherein the multiple improved bit samples comprise 16 match filtered bit samples.

15. The Radio Data System receiver of claim 11 wherein estimating the signal magnitude comprises calculating a peak index for the multiple bit samples.

16. The Radio Data System receiver of claim 15 wherein the peak index is updated every 64 bits.

17. The Radio Data System receiver of claim 11 wherein differentially decoding the selected sample comprises conjugating a current bit sample with a previous bit sample to produce a phase angle between the two samples and using the phase angle to map the selected sample to a binary data bit value of either 0 or 1.

18. The Radio Data System receiver of claim 11 wherein filtering the signal comprises processing an I component and a Q component of the received signal with separate matched filters.

19. The Radio Data System receiver of claim 11 wherein selecting the best sample comprises averaging a running sum of the estimated signal magnitudes.

20. The Radio Data System receiver of claim 11 wherein selecting the best bit sample comprises adding and/or dropping bit samples.

21. A wireless device comprising:
a wireless communications transceiver and associated antenna(s) capable of sending and receiving wireless communications signals;
a modem coupled to the transceiver comprising processor(s) for processing signals and executing code stored in a memory;
a power management unit coupled to the modem and the transceiver for measuring and controlling transmit power; and
a memory coupled to the modem for storing instructions for filtering a received Radio Data System signal having no pilot or a an unsynchronized data subcarrier to produce multiple improved bit samples, estimating the signal magnitude of the multiple bit samples, selecting the best bit sample from the multiple samples and differentially decoding the selected sample to produce a received Radio Data System data bit value.

22. The wireless device of claim 21 wherein receiving the wireless communications signal comprises receiving a mono RDS signal and generating a local 19 kHz local clock signal.

23. The wireless device of claim 22 wherein a local 57 kHz local clock signal is generated from the local 19 kHz clock signal.

24. The wireless device of claim 21 wherein the multiple improved bit samples comprise 16 match filtered bit samples.

25. The wireless device of claim 21 wherein estimating the signal magnitude comprises calculating a peak index for the multiple bit samples.

26. The wireless device of claim 25 wherein the peak index is updated every 64 bits.

27. The wireless device of claim 21 wherein differentially decoding the selected sample comprises conjugating a current bit sample with a previous bit sample to produce a phase angle between the two samples and using the phase angle to map the selected sample to a binary data bit value of either 0 or 1.

28. The wireless device of claim 21 wherein filtering the signal comprises processing an I component and a Q component of the received signal with separate matched filters.

29. The wireless device of claim 21 wherein selecting the best sample comprises averaging a running sum of the estimated signal magnitudes.

30. The wireless device of claim 21 wherein selecting the best bit sample comprises adding and/or dropping bit samples.

31. A computer readable medium having instructions stored thereon to cause a processor in a wireless device to:
receive a Radio Data Systems signal having no pilot, or a an unsynchronized data subcarrier;
filter the received signal to produce multiple improved bit samples;
estimate the signal magnitude of the multiple bit samples;
select the best bit sample from the multiple samples; and
differentially decode the selected sample to produce a received RDS data bit value.

32. The computer readable medium of claim 31 wherein receiving the Radio Data Systems signal comprises receiving a mono signal and generating a local 19 kHz local clock signal.

33. The computer readable medium of claim 32 wherein a local 57 kHz local clock signal is generated from the local 19 kHz clock signal.

34. The computer readable medium of claim 31 wherein the multiple improved bit samples comprise 16 match filtered bit samples.

35. The computer readable medium of claim 31 wherein estimating the signal magnitude comprises calculating a peak index for the multiple bit samples.

36. The computer readable medium of claim 35 wherein the peak index is updated every 64 bits.

37. The computer readable medium of claim 31 wherein differentially decoding the selected sample comprises conjugating a current bit sample with a previous bit sample to produce a phase angle between the two samples and using the phase angle to map the selected sample to a binary data bit value of either 0 or 1.

38. The computer readable medium of claim 31 wherein filtering the signal comprises processing an I component and a Q component of the received signal with separate matched filters.

39. The method of claim 1 wherein selecting the best sample comprises averaging a running sum of the estimated signal magnitudes.

40. The computer readable medium of claim 31 wherein selecting the best bit sample comprises adding and/or dropping bit samples.

41. A means for receiving RDS data comprising:
means for receiving a Radio Data Systems signal having no pilot, or a an unsynchronized data subcarrier;
means for filtering the received signal to produce multiple improved bit samples;
means for estimating the signal magnitude of the multiple bit samples;
means for selecting the best bit sample from the multiple samples; and
means for differentially decoding the selected sample to produce a received RDS data bit value.

42. The means for receiving RDS data of claim 41 wherein receiving the Radio Data Systems signal comprises receiving a mono signal and generating a local 19 kHz local clock signal.

43. The means for receiving RDS data of claim 42 wherein a local 57 kHz local clock signal is generated from the local 19 kHz clock signal.

44. The means for receiving RDS data of claim 41 wherein the multiple improved bit samples comprise 16 match filtered bit samples.

45. The means for receiving RDS data of claim 41 wherein estimating the signal magnitude comprises calculating a peak index for the multiple bit samples.

46. The means for receiving RDS data of claim 45 wherein the peak index is updated every 64 bits.

47. The means for receiving RDS data of claim 41 wherein differentially decoding the selected sample comprises conjugating a current bit sample with a previous bit sample to produce a phase angle between the two samples and using the phase angle to map the selected sample to a binary data bit value of either 0 or 1.

48. The means for receiving RDS data of claim 41 wherein filtering the signal comprises processing an I component and a Q component of the received signal with separate matched filters.

49. The means for receiving RDS data of claim 41 wherein selecting the best sample comprises averaging a running sum of the estimated signal magnitudes.

50. The means for receiving RDS data of claim 41 wherein selecting the best bit sample comprises adding and/or dropping bit samples.
